(19) United States
(12) Patent Application Publication
(10) Pub. No.: US 2019/0227841 A1
(43) Pub. Date: Jul. 25, 2019

(54) ARBITRATION OF MULTIPLE REQUESTS

(71) Applicant: Intel Corporation, Santa Clara, CA (US)

(72) Inventors: John MORAN, Leixlip (IE); Ireneusz SOBANSKI, Clarecastle (IE); Edward BRAZIL, Leixlip (IE)

(21) Appl. No.: 16/373,501

(22) Filed: Apr. 2, 2019

(51) Int. Cl. G06F 9/48; G06F 9/30

(52) U.S. Cl. CPC G06F 9/4881; G06F 9/30061; G06F 9/4818

(57) ABSTRACT

In some examples, multiple requesters request use of a resource and a single request is granted. A priority scheme can be set such that among pairs of requests, the lower numbered request is advanced. After one or more rounds of arbitration, a determination is made as to which request to grant. In a case where higher priority requesters are to be identified, masks can be used to mask out requests from non-higher priority requesters in a subsequent round. A mask can be generated for any requester that is at or below the priority level of the requester that had its request granted. Accordingly, when a high priority arbiter is used to set another priority level, the mask(s) can be used to indicate the higher priority requests.

### TECHNICAL FIELD

Various examples described herein relate to arbitration among multiple requesters.

### BACKGROUND

Arbitration schemes are used in a variety of contexts to select a highest priority request to access a shared resource. Various arbitration schemes are available for use in selecting a request to grant. Fixed priority arbitration is a commonly used arbitration scheme. Fixed priority arbitration can be implemented using a binary-tree structure with an up-trace and down-trace of the tree. In the up-trace, a series of de-multiplexer paths are configured. According to this scheme, in each pair of requestors, the left requestor is given priority over the right requestor and the de-multiplexer paths are configured accordingly. During an up-trace, the all active priority request signals traverse the configured paths and a higher priority request is granted. In the down-trace, the grant signal (generated from OR'ing of all requests) traverses down the path configured during the up-trace in order to identify the highest priority requestor.

Up-trace and down-trace aspects of arbitration can be time consuming. For increasing numbers of requesters, it is desirable to reduce the time taken for up-trace and down-trace.

### BRIEF DESCRIPTION OF THE DRAWINGS

FIG. 1 illustrates examples of fixed priority arbitration.

FIG. 2 depicts an example of round robin arbitration by adjusting the position of the high priority requestor based on the last granted requestor.

FIG. 3 shows an example in which two fixed priority arbiters (FPA) can be used to provide for round robin arbitration.

FIG. 4 defines the nodes of the binary tree in one example.

FIG. 5 depicts an example of down-trace connectivity between nodes.

FIG. 6 depicts an example illustration of rules of a priority spawning embodiment.

FIGS. 7A and 7B depict priority spawning examples for two scenarios.

FIG. 8A depicts an example of a circuit that can be used for a root node.

FIG. 8B depicts an example of a circuit that can be used for an intermediate node.

FIG. 8C depicts an example of a circuit that can be used for a leaf node.

FIG. 8D depicts an example timing diagram.

FIG. 9A shows another example of a root node circuit in a dual arbiter configuration.

FIG. 9B shows an example of an intermediate node circuit in a dual arbiter configuration.

FIG. 9C shows an example of a leaf node circuit in a dual arbiter configuration.

FIG. 10 depicts an example of connectivity of the tree arbiter for a 4 requestor case.

FIG. 11 depicts an example process.

FIG. 12 depicts a system.

FIG. 13 depicts a network interface.

FIG. 14 depicts an example of a data center.

### DETAILED DESCRIPTION

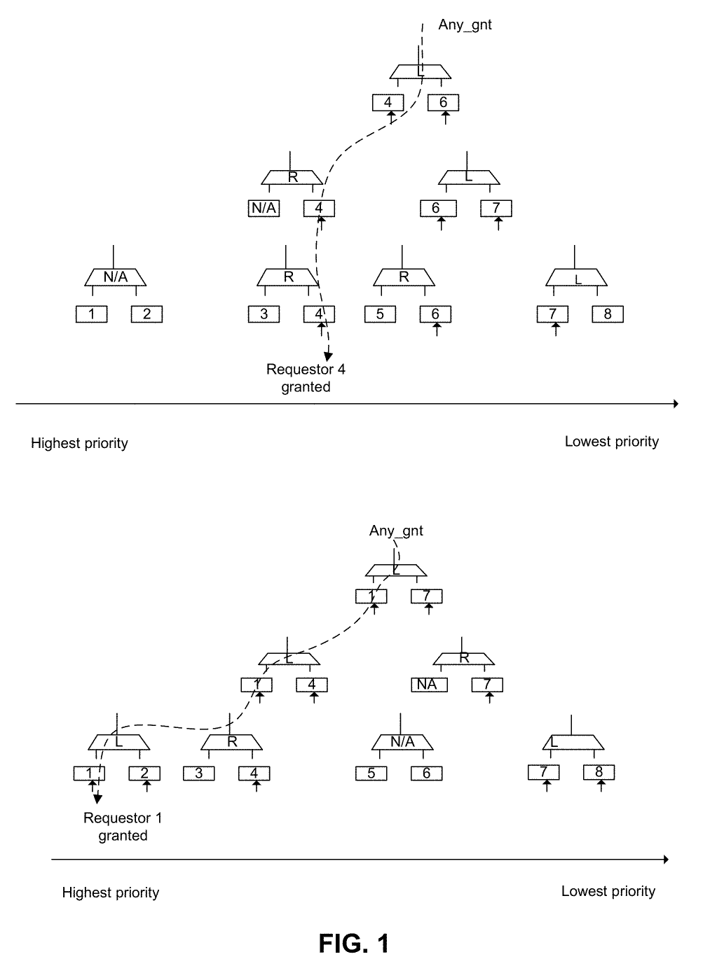

FIG. 1 illustrates examples of fixed priority arbitration. In the upper example of FIG. 1, no requests are provided as inputs 1 and 2, but requests are provided for inputs 4, 6, and 7. During an up-trace, requests 4, 6, and 7 advance to a next round and inputs 4 and 6 are provided to the final round. During the downtrace, input 4 is left of input 6 and input 4 is granted.

In the lower example of FIG. 1, requests are provided for inputs 1 and 2, 4, and 7 and 8. During an up-trace, inputs 1, 4, and 7 advance to a next round. In the next round of the up-trace, inputs 1 and 7 are advanced. In a final round, input 1 is selected for being left of input 7 and input 1 is granted.

Various embodiments provide for a manner of high speed round robin arbitration that can potentially reduce a time to advance requests during a down-trace section of an arbitration. As a number of requestors increases, various embodiments can be used to provide timely request grants. According to some embodiments, a digital code is generated and the code can be used to identify lower and higher priority requestors for a next arbitration stage. In a binary tree arbiter, there can be an up-trace stage and a down-trace stage. Various embodiments can provide that both stages can be completed in O(log 2N) (big O notion) logic levels, where N is the number of requestors. In some examples, 2 log 2(N−1)+2 logic levels can achieve round robin arbitration over N requestors in both the up and down trace. A logic level can be a number of gates that a signal passes through. Various embodiments can be used in networking applications. For example, a requester could correspond to a quality of service queue in a network interface or packet networking environment and a requested resource can be packet processing resources.

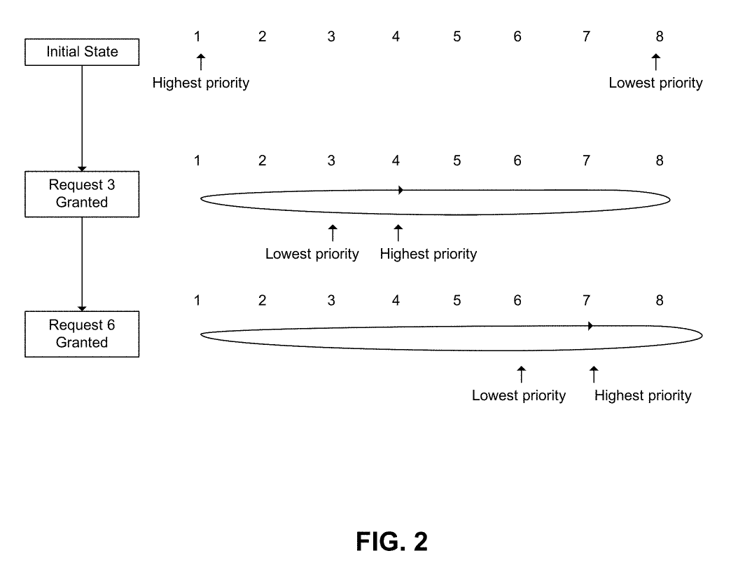

A fixed priority arbitration can be transformed into round robin arbitration by adjusting the position of the high priority requestor based on the last granted requestor. FIG. 2 depicts an example of round robin arbitration by adjusting the position of the high priority requestor based on the last granted requestor. Initially, requester 1 is considered the highest priority requestor and requester 8 is considered the lowest priority request. This illustrated case shows requestor 3 is granted, and for a next round, a highest priority is requestor 4 and requesters 1-3 are considered lower priority requestors. In a next round, a requestor 6 provides a request and because it is the highest level request, it is granted. For the next round, a highest priority level is changed to 7, which is greater than the requestor 6, and requestors 1-6 are considered low priority.

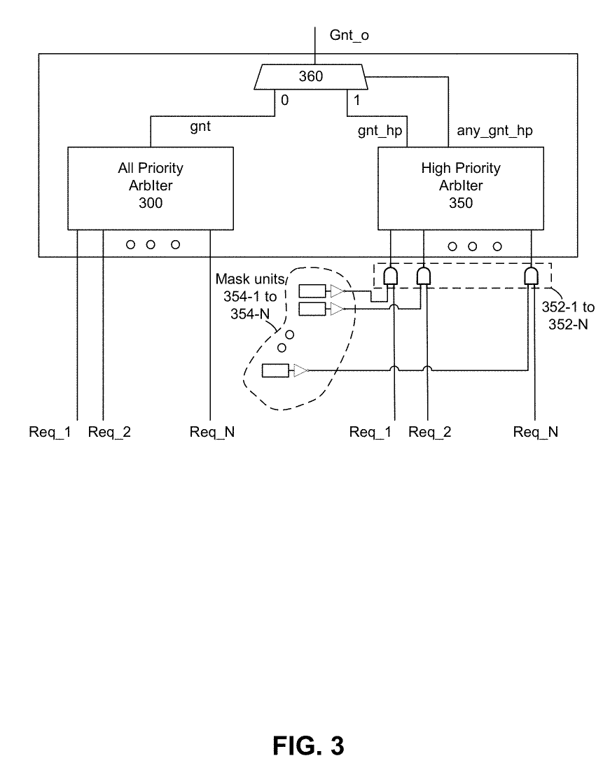

FIG. 3 shows an example in which two fixed priority arbiters (FPA) can be used to provide for round robin arbitration. Various embodiments use mask units 354-1 to 354-N to change a highest priority level requester for each round of arbitration. For example, the example of FIG. 2 could use the embodiments described with respect to FIG. 3 to set a highest priority requester and lower priority requesters. In some examples, a single clock cycle can be used (or a portion of a clock cycle) to up-trace and down-trace and identify a highest priority requester and lower priority requesters. One of these arbiters is driven only by the high priority requestors (arbiter 350) and the other arbiter (arbiter 300) is driven by all requestors. According to one arbitration scheme, the high priority requestors are the requestors to the left, but other schemes can be used (e.g., higher priority is to the right). Requests from high priority requestors are transferred but requests from lower priority requesters are masked using the LP signal outputs from mask units 354-1 to 354-N. If high priority arbiter 350 has any requests, then its output is transferred by multiplexer 360 in order to set the highest priority request(s); otherwise the highest priority output from all priority arbiter 300 is transferred by multiplexer 360.

All priority arbiter 300 can receive requester inputs from requesters 1 to N (shown as Req_1 to Req_N). All priority arbiter 300 can select a highest priority output and provide the output as a grant using signal gnt.

High priority arbiter 350 can receive inputs from AND gates 352-1 to 352-N. AND gates 352-1 to 352-N receive (inverted) inputs from respective mask units 354-1 to 354-N and requester inputs from requesters 1 to N (shown as Req_1 to Req_N). For example, AND gate 352-1 can receive inputs from mask unit 354-1 and Req_1, AND gate 352-2 can receive inputs from mask unit 354-2 and Req_2, and so forth. If an input to a mask unit is 1, then an output from the mask unit to an AND gate is a 0 (masks requester input), which causes an output from an AND gate to be 0 and the corresponding request to be masked. Requests from lower priority requesters can be masked using mask units 354-1 to 354-N. Various embodiments provide a manner of determining and providing inputs to mask units 354-0 to 354-N−1.

Based on unmasked request inputs, high priority arbiter 350 can select a highest priority output and provide the output as a grant using signal gnt_hp. Moreover, high priority arbiter 350 can provide a signal that indicates an output at signal gnt_hp is available using signal any_gnt_hp. Signal any_gnt_hp can inform a multiplexer 360 to provide an input from high priority arbiter 350 such that input gnt_hp is selected over signal gnt from all priority arbiter 300. Multiplexer 360 provides an output Gnt_o.

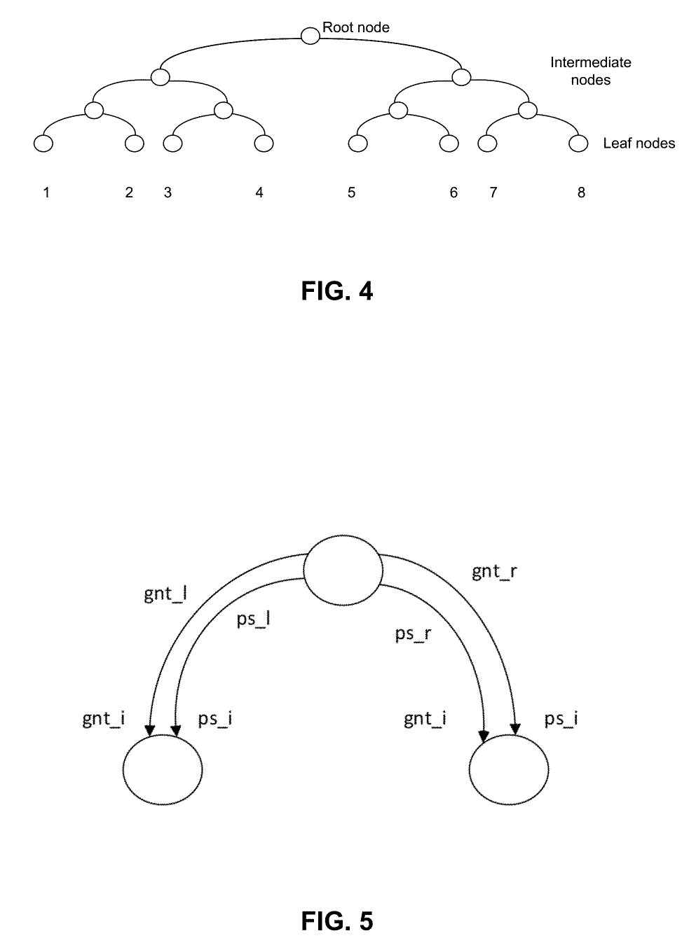

FIG. 4 defines the nodes of the binary tree in one example. Leaf nodes represent requesters and can include requests from requesters 1 to 8, in this example, although other numbers of leaf nodes can be used. Intermediate nodes represent higher priority requesters among groups of requesters 1 and 2, requesters 3 and 4, requesters 5 and 6, and requesters 7 and 8. According to a priority scheme, a lower number request in any group of requesters (left side) advances. In this example, there are three levels of advancements: two intermediate nodes and a root node advancement of requests. In this example, a root node provides a granted requester. In an up-trace, selection can occur from among requesters in groups of 1 and 2, 3 and 4, 5 and 6, and 7 and 8 (if any). Then a winner from each group can be compared and the lower requester number is advanced. The root node selects and advances a request from the lowest numbered requester.

FIG. 5 depicts an example of down-trace connectivity between nodes. Down-trace connectivity can be applied after an up-trace is used to identify a request to grant and corresponding requester. The scheme can be applied for a root node, intermediate node, and/or leaf node. Indicator gnt=1 indicates a grant issued to a left node. Indicator gnt_r=1 indicates a grant issued to a right node. Indicator gnt_i identifies an output from a higher level node and is either the value of gnt_l or gnt_r from a parent node. Indicator ps_l=1 indicates a priority spawn left whereas indicator ps_r=1 indicates a priority spawn right. Indicator ps_i indicates a priority spawn input and is the value of ps_l or ps_r from a parent node.

The following pseudocode can be used to identify the lower priority requestors after each grant or a priority spawn signal (lower priority node). This recursive algorithm can be applied during the down trace section of the arbitration phase and after a requester grant has been selected during an up-trace.

PSEUDOCODE EXAMPLE

Set node = root

Priority spawn(node) {

If (node ==root)

If (grant to right child)

```
  Set ps_l //ps_l = priority spawn left
  Priority_spawn(left child)
  Priority_spawn(right child)
```

Else(if grant to left child)

Priority_spawn(left child)

If (node ==inter node)

If (priority spawn in)

```
  Set ps_1
  Priority spawn(left child)
  Set ps_r
  Priority spawn(Right child)
```

Else if(grant to right child)

```
  Set ps_l
  Priority spawn(left child)
```

If (node == leaf node)

If(ps_i or gnt_i)

Set leaf_node as a low priority node

Return

} end Priority spawn

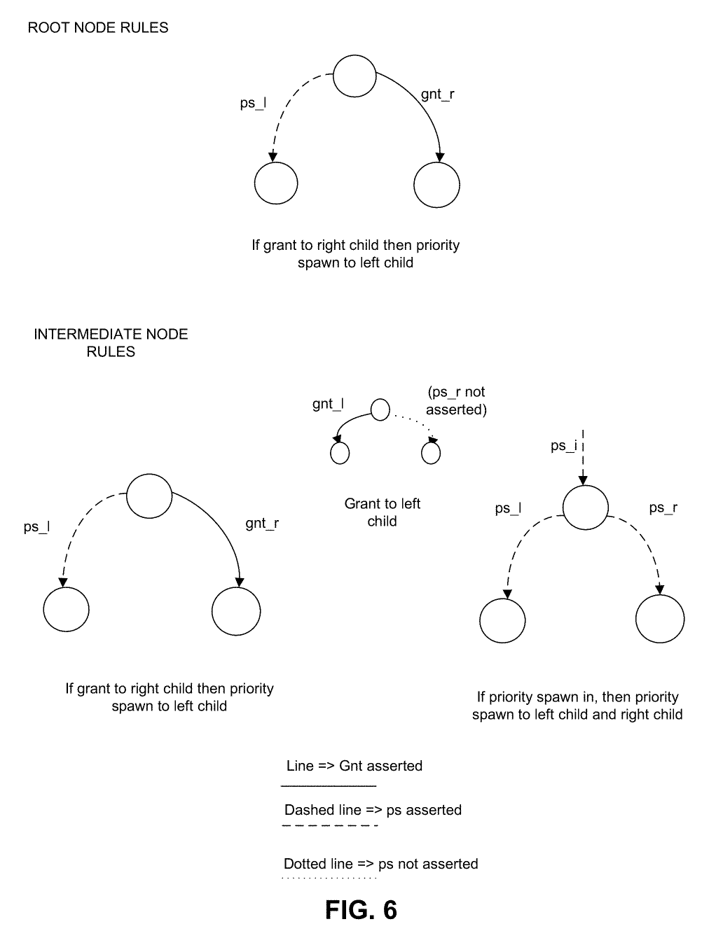

FIG. 6 depicts an example illustration of rules of a priority spawning embodiment. From a root node, if a grant is to a right child node (direct or indirect), then gnt_r=1 and a priority spawn is to the left child (ps_l=1). However, from the root node, if a grant is to a left child node (direct or indirect), then gnt_l=1.

For an intermediate node that is below either the root node or below another intermediate node, several outputs can be provided. An intermediate node that receives a grant gnt_i from/of either gnt_r or gnt_l from its parent node can generate a gnt_r=1 and ps_l=1 if an uptrace de-multiplexer configuration signal indicates that a right requester was selected (e.g., no left side requester made a request) or generate a gnt_l=1 if an uptrace de-multiplexer configuration signal indicates that a left requester was selected

An intermediate node that receives a priority spawn signal ps_i of either ps_l or ps_r from a parent node and has no child node that received a grant will provide both ps_l and ps_r as set to 1. For example, for a root node that has a ps_l=1, all children (direct and indirect) under the root node branch with ps_l=1 have both ps_l and ps_r set to 1. As another example, for an intermediate node that receives at ps_i an input of ps_r=1 will provide both ps_l and ps_r set to 1. Accordingly, all children of type leaf with a ps_l or ps_r signal set to 1 are considered to have low priority spawn and their requests can be masked in the next request round.

At a leaf (end) node, if a priority spawn input from its parent node has a ps_r or ps_l set to 1, then a ps_i for the node is set to 1 and the leaf node has a low priority designation and its request is masked in the next request round. If its parent node has a gnt_l set 1, then the left leaf node has its output considered low priority and is masked in the next request round. However, if a leaf node receives no gnt or ps signal, the leaf node is considered higher priority and its request is not gated to the arbiter in the next request round.

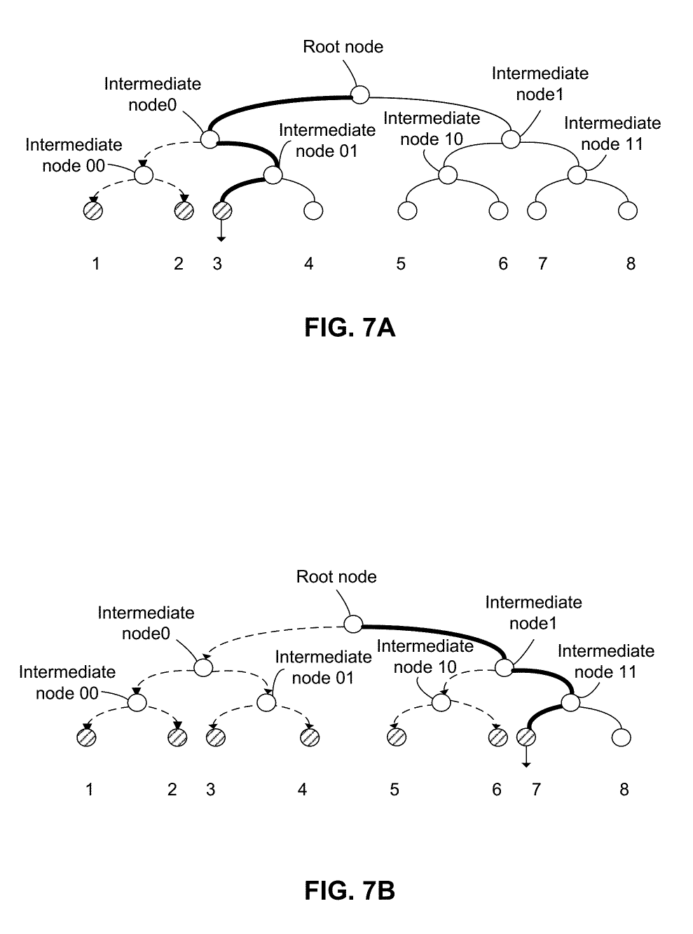

FIGS. 7A and 7B depict priority spawning examples for two scenarios. In FIG. 7A, a request from requestor 3 is granted during an up-trace. During the down-trace, root node identifies that intermediate node0 includes the granted node based on uptrace de-mux configuration being set to left which causes gnt_l=1 but ps_r is not asserted. At intermediate node0, uptrace de-mux configuration was set to advance the right side input (from uptrace), which causes its output to be gnt_r=1 and ps_l=1. Intermediate node00 receives ps_i=1, which causes ps_l and ps_r to be both set to 1. Intermediate node01 receives gnt_i=1 and uptrace de-mux configuration was asserted left (during the up-trace), which causes gnt_l=1 to be asserted.

Leaf node 1 receives a ps_i of 1, which causes a 1 to be captured by its masking unit. Leaf node 2 receives a ps_i of 1, which causes a 1 to be captured by its masking unit. Dashed lines identify nodes to left are considered lower priority (e.g., requesters 1 and 2). Leaf node 3 receives a gnt_i of 1, which causes a 1 to be captured by its masking unit. Leaf node 4 receives neither an asserted gnt_i or a ps_i, which causes a 0 to be captured by its masking unit.

Referring to the right side of the tree, intermediate node1 receives from its root node a gnt_i and ps_i of 0s (irrespective of its uptrace de-mux configuration), which propagates zeros through ps_l and ps_r to intermediate nodes 10 and 11. Intermediate node 10 also propagates all zeros through ps_l and ps_r to leaf nodes 5 and 6 (irrespective of its uptrace de-mux configuration) and intermediate node 11 propagates all zeros through ps_l and ps_r to leaf nodes 7 and 8 (irrespective of its uptrace de-mux configuration).

Accordingly, an input “1” is provided to masking units associated with requesters 1-3 and an input “0” is provided to masking units associated with requesters 4-8. Referring to FIG. 3, the output from the masking units is an inverted version of an input, and the output to an AND gate is a 0 (low priority) for requesters 1-3 so that, during a next request round, requests from requesters 1-3 are masked and do not provide an input to high priority arbiter 350 but requests from requesters 4-8 are provided to high priority arbiter 350. In the next round, the outputs from masking units 354-1 to 354-8 are provided to high priority arbiter 350 to permit higher priority requests to proceed to multiplexer 360.

FIG. 7B shows another example. In this example, during an up-trace, a request from requester 7 is granted. In this example, a request from requester 7 is selected and, during a down-trace, nodes 1-7 are selected as lower priority requesters for adjusting a position of a high priority requester (e.g., requester 8). Root node has a gnt_r=1 asserted but ps_l is not asserted. Intermediate node0 receives a ps_i input of 1, which propagates ps_l and ps_r as ones to intermediate nodes 00 and 01 (irrespective of its uptrace de-mux configuration). Intermediate node 00 receives ps_i of one and also propagates ps_l and ps_r as ones to leaf nodes 1 and 2 (irrespective of its uptrace de-mux configuration) and intermediate node 01 propagates ps_l and ps_r as ones to leaf nodes 3 and 4 (irrespective of its uptrace de-mux configuration). Dash lines identifies nodes to left are considered lower priority (e.g., requesters 1-4).

Intermediate node1 receives a gnt_i=1 and its uptrace de-mux configuration is set to right (from the uptrace), which causes its output to be gnt_r=1 and ps_l=1. Intermediate node10 receives ps_i=1 which causes ps_l and ps_r to be asserted as 1 (irrespective of its uptrace de-mux configuration). Accordingly, requesters 5 and 6 receive inputs of 1. Intermediate node11 receive gnt_i=1 and its uptrace de-mux configuration is asserted left, which causes gnt_ll=1 to be asserted.

Accordingly, leaf nodes 1-7 all receive a ps_i of 1, which causes a 1 to be captured by their associated masking unit. Requesters 1-7 are identified as lower priority requests and their outputs are masked. However, leaf node 8 receives neither a grant or a ps, which causes a 0 to be captured by its masking unit. Accordingly, an input “1” is provided to masking units associated with requesters 1-7 and an input “0” is provided to masking unit associated with requester 8. Referring to FIG. 3, the output from the masking units is an inverted version of an input, and the output to an AND gate is a 0 (low priority) for requesters 1-7 so that, during a next request round, requests from requesters 1-7 are masked and do not provide an input to high priority arbiter 350 but a request from requester 8 is provided to high priority arbiter 350. In the next request round (e.g., next clock cycle or subsequent clock cycle), the outputs from masking units 354-1 to 354-8 (respective requesters 1-8) are provided to high priority arbiter 350 to permit higher priority requests to proceed to multiplexer 360.

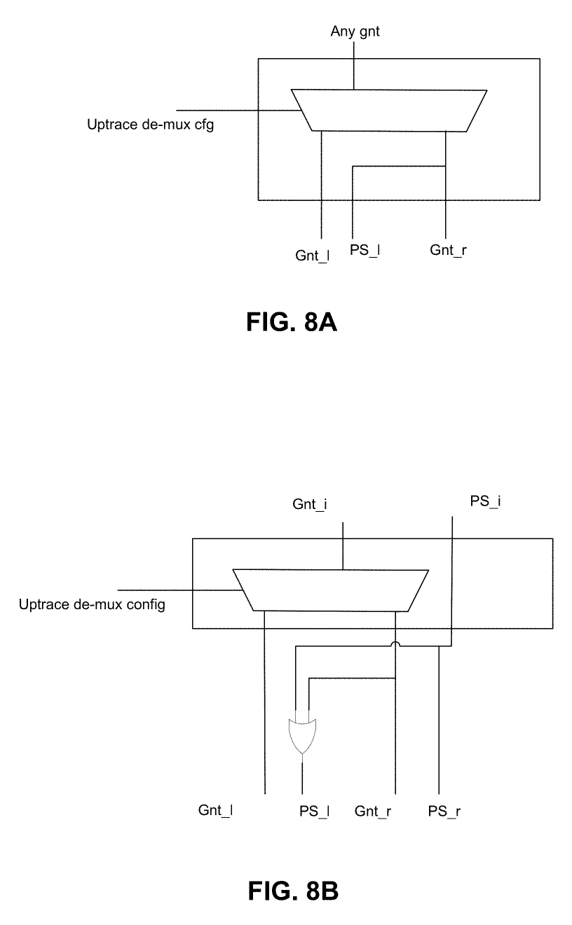

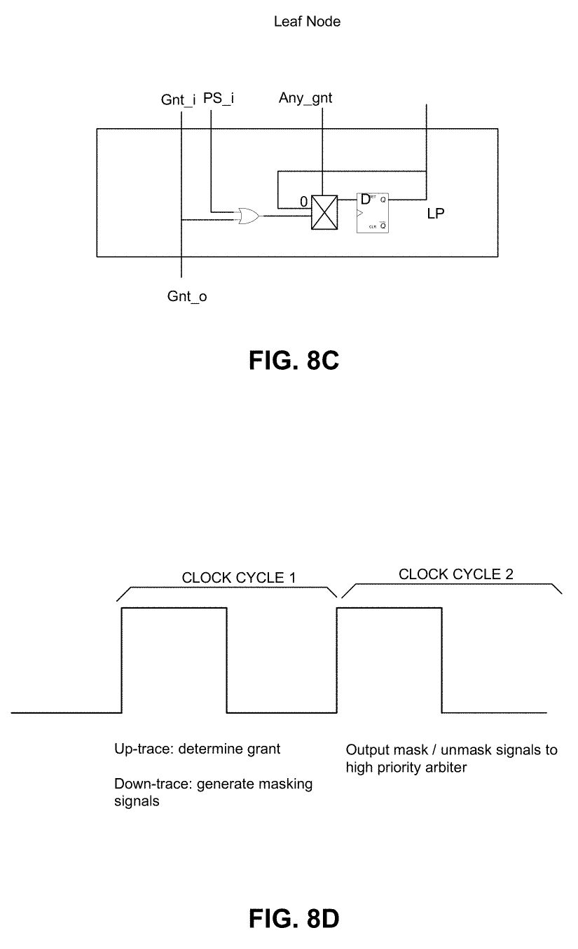

FIG. 8A depicts an example of a circuit that can be used for a root node. A root node can provide outputs of gnt_l, ps_l, and gnt_r based on uptrace de-mux configuration (cfg) signal. During an uptrace, setting de-mux configuration to left (on the uptrace) causes gnt_l to be asserted on the down trace. Conversely, during an uptrace, setting de-mux configuration to right (on the uptrace) causes gnt_r to be asserted on the down trace. During a down-trace, a de-mux config signal asserted/de-asserted during an up-trace can remain asserted/de-asserted. Signal Any_gnt indicates any requestor is present and a requestor's request has been granted during the up-trace.

FIG. 8B depicts an example of a circuit that can be used for an intermediate node. An uptrace de-mux configuration is set to left (from uptrace) and an input of gnt_i=1 causes its output to be gnt_l=1. An uptrace de-mux configuration set to right (from uptrace) and an input of gnt_i=1 causes its output to be gnt_r=1 and ps_l=1. However, irrespective of an uptrace de-mux configuration setting, an input of ps_i=1 causes outputs ps_l and ps_r to be set to 1.

FIG. 8C depicts an example of a circuit that can be used for a leaf node. An input ps_i of 1 causes a 1 to be captured in the flip flop. Receipt of a gnt_i=1, causes a 0 to be captured in the flip flop. Accordingly, an output from the flip flop is output in a next round (e.g., 1 or 0).

FIG. 8D depicts an example timing diagram. In a clock cycle 1, an up-trace can be used to determine a requester to grant and also determine masking signals for use in a next arbitration round for a new high priority designation. In a clock cycle 2, an output from the masking units is provided to a high priority arbiter to set high priority levels. Note that masking outputs can be provided in a clock cycle immediately after an down-trace or any clock cycle.

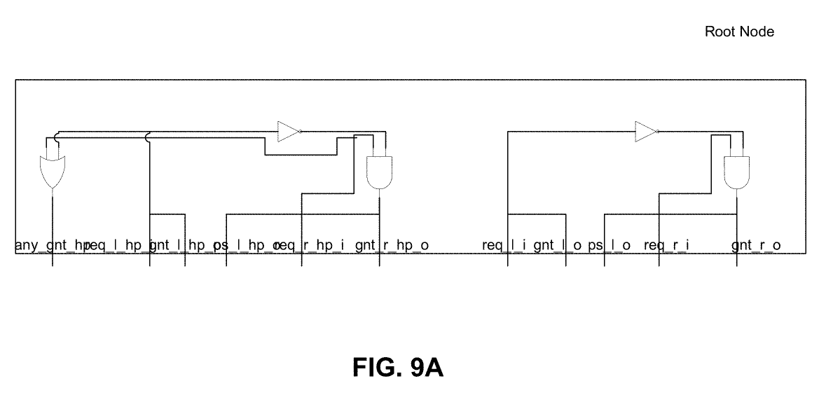

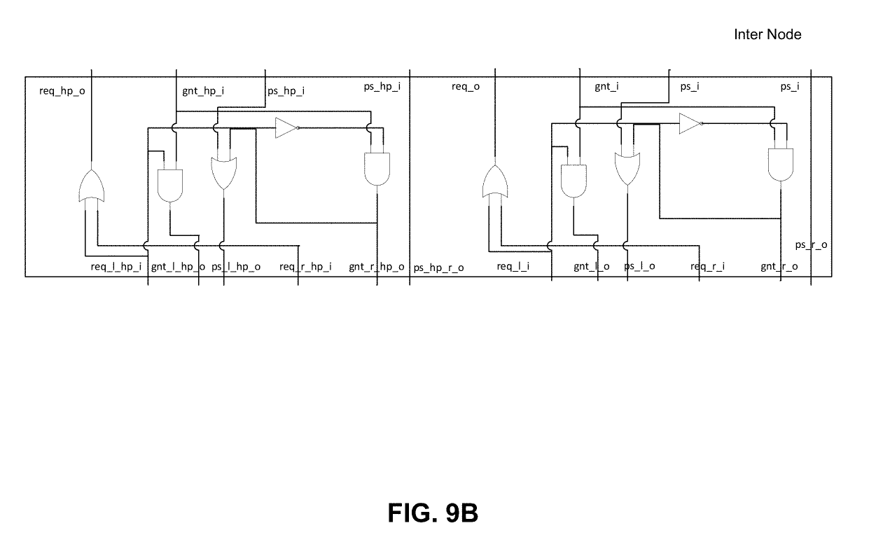

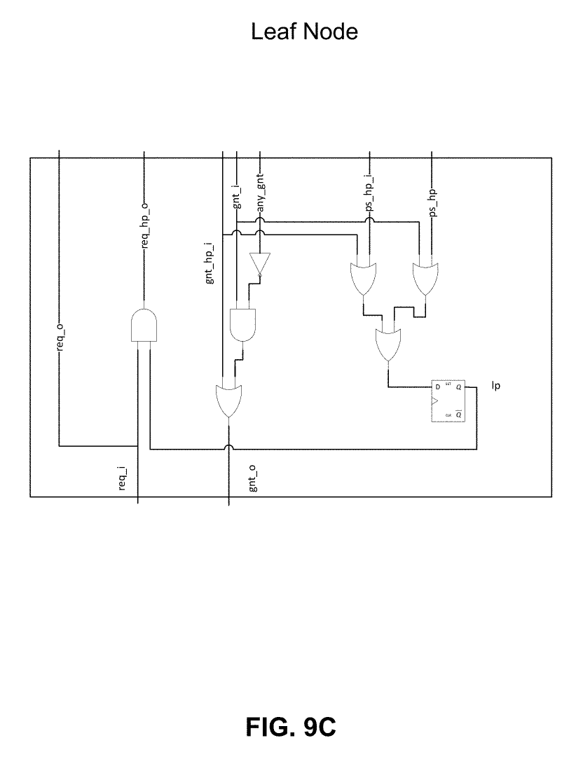

FIG. 9A shows another example of a root node circuit. For example, logic relationship between nodes can be as follows.

gnt_l_o=req_l_i
gnt_r_o=˜req_i. req_r_i
gnt_l_hp_o=req_l_hp_i
gnt_r_hp_o=˜req_l_hp_i. req_r_hp_i;
ps_l_o=gnt_r_o
ps_l_hp_o=gnt_r_hp_o
any_gnt_hp=req_l_hp_i+req_r_hp_i;
any_gnt=req_l+req_r;

FIG. 9B shows an example of a inter node circuit. For example, logic relationship between nodes can be as follows:

req_o=req_l_i+req_r_i
req_hp_o=req_l_hp_i+req_r_hp_i
gnt_l_o=req_l_i. gnt_i
gnt_r_o=˜req_l_i. gnt_i
gnt_l_hp_o=req_l_hp_i. gnt_hp_i
gnt_r_hp_o=˜req_l_hp_i. gnt_hp_i
ps_l_o=gnt_r_o+ps_i
ps_r_o=ps_i
ps_l_hp_o=gnt_r_hp_o+ps_hp_i
ps_r_hp_o=ps_hp_i

FIG. 9C shows an example of a leaf node circuit. For example, logic relationship between nodes can be as follows:

gnt_o=gnt_hp_i+(˜any_gn_thp && gnt_i);
req_o=req_i;
req_hp_o=req_i && ˜lp;
lp_next=(ps_hp_i∥gnt_hp_i)∥(ps_i∥gnt_i);
req_i=1/0 for positions 1-8

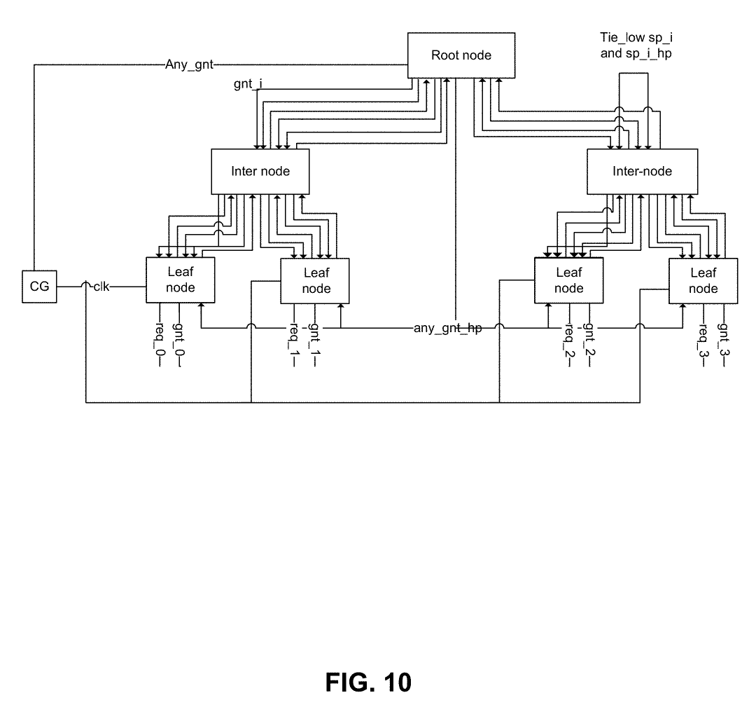

FIG. 10 depicts an example of connectivity of the tree arbiter for a 4 requestor case. Asymmetry on the right hand side of the tree can be used. Namely, the priority spawn (ps) inputs are tied to low on the right most inter-nodes. Clock gating cell (CG) entering the leaf nodes can ensure that the priority state flops retain their state when no traffic is present.

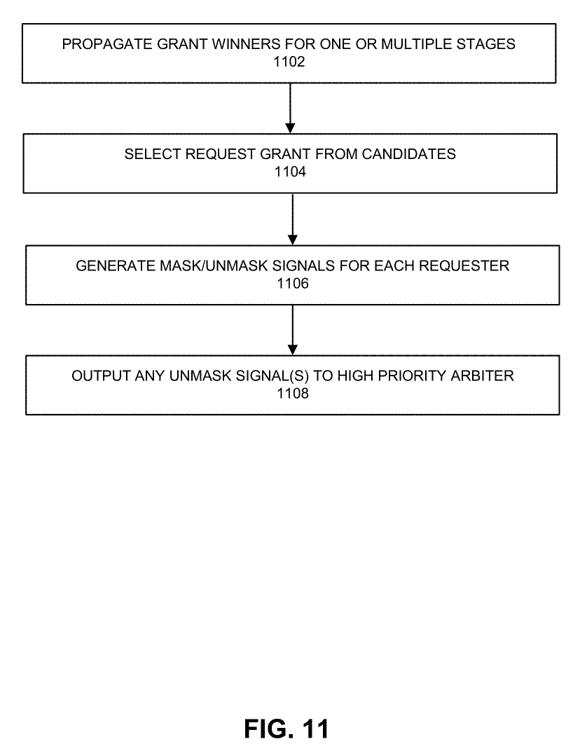

FIG. 11 depicts an example process. At 1102, grant winners are propagated for one or multiple stages. For example, grant requests from groups of one or more requesters can be received and a winner selected at a stage. At a next stage, winner requests can be received and another winner selected. In some example, a lower numbered requester can be given priority, although other schemes can be used. At 1104, a grant is selected from among a group of one or more winners from one or more prior stages. Actions 1102 and 1104 can occur in an up-trace segment using an arbitration device.

At 1106, mask or unmask signals can be generated for requesters. For example, for a granted request and lower priority requests (e.g., to the left of the granted requester number), mask signals can be generated. For higher priority requests (e.g., to the right of the granted requester number), unmask signals can be generated. Action 1106 can be performed during a down-trace operation. In some embodiments, actions 1102-1106 can be performed in a single clock cycle.

At 1108, any available unmasked request signals are output to the high priority arbiter. For example, masked signals can cause requests to the high priority arbiter to be masked and not provided to the high priority arbiter whereas unmasked signals can permit requests to the high priority arbiter to not be masked. In some embodiments, a next clock cycle, immediately after or after the clock cycle in which the mask or unmask signals were generated, is used to output unmasked request signals to the high priority arbiter. Requests that are unmasked are provided to the high priority arbiter. Accordingly, unmasked requests are provided as higher priority requests. A high priority arbiter can output the highest priority unmasked request. In a subsequent round, a highest priority level can be selected using the process.

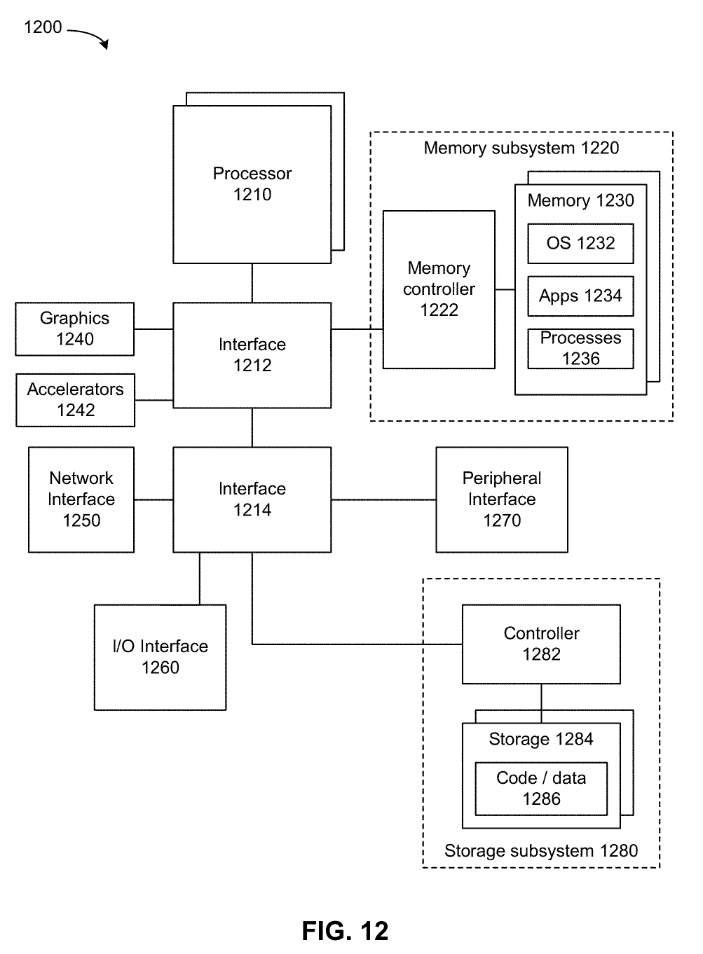

FIG. 12 depicts a system. The system can use embodiments described herein. System 1200 includes processor 1210, which provides processing, operation management, and execution of instructions for system 1200. Processor 1210 can include any type of microprocessor, central processing unit (CPU), graphics processing unit (GPU), processing core, or other processing hardware to provide processing for system 1200, or a combination of processors. Processor 1210 controls the overall operation of system 1200, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1200 includes interface 1212 coupled to processor 1210, which can represent a higher speed interface or a high throughput interface for system components that needs higher bandwidth connections, such as memory subsystem 1220 or graphics interface components 1240. Interface 1212 represents an interface circuit, which can be a standalone component or integrated onto a processor die. Where present, graphics interface 1240 interfaces to graphics components for providing a visual display to a user of system 1200. In one example, graphics interface 1240 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1240 generates a display based on data stored in memory 1230 or based on operations executed by processor 1210 or both. In one example, graphics interface 1240 generates a display based on data stored in memory 1230 or based on operations executed by processor 1210 or both.

Memory subsystem 1220 represents the main memory of system 1200 and provides storage for code to be executed by processor 1210, or data values to be used in executing a routine. Memory subsystem 1220 can include one or more memory devices 1230 such as read-only memory (ROM), flash memory, one or more varieties of random access memory (RAM) such as DRAM, or other memory devices, or a combination of such devices. Memory 1230 stores and hosts, among other things, operating system (OS) 1232 to provide a software platform for execution of instructions in system 1200. Additionally, applications 1234 can execute on the software platform of OS 1232 from memory 1230. Applications 1234 represent programs that have their own operational logic to perform execution of one or more functions. Processes 1236 represent agents or routines that provide auxiliary functions to OS 1232 or one or more applications 1234 or a combination. OS 1232, applications 1234, and processes 1236 provide software logic to provide functions for system 1200. In one example, memory subsystem 1220 includes memory controller 1222, which is a memory controller to generate and issue commands to memory 1230. It will be understood that memory controller 1222 could be a physical part of processor 1210 or a physical part of interface 1212. For example, memory controller 1222 can be an integrated memory controller, integrated onto a circuit with processor 1210.

While not specifically illustrated, it will be understood that system 1200 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 13124 bus.

In one example, system 1200 includes interface 1214, which can be coupled to interface 1212. In one example, interface 1214 represents an interface circuit, which can include standalone components and integrated circuitry. In one example, multiple user interface components or peripheral components, or both, couple to interface 1214. Network interface 1250 provides system 1200 the ability to communicate with remote devices (e.g., servers or other computing devices) over one or more networks. Network interface 1250 can include an Ethernet adapter, wireless interconnection components, cellular network interconnection components, USB (universal serial bus), or other wired or wireless standards-based or proprietary interfaces. Network interface 1250 can transmit data to a remote device, which can include sending data stored in memory. Network interface 1250 can receive data from a remote device, which can include storing received data into memory. Various embodiments can be used in connection with network interface 1250, processor 1210, and memory subsystem 1220.

In one example, system 1200 includes one or more input/output (I/O) interface(s) 1260. I/O interface 1260 can include one or more interface components through which a user interacts with system 1200 (e.g., audio, alphanumeric, tactile/touch, or other interfacing). Peripheral interface 1270 can include any hardware interface not specifically mentioned above. Peripherals refer generally to devices that connect dependently to system 1200. A dependent connection is one where system 1200 provides the software platform or hardware platform or both on which operation executes, and with which a user interacts.

In one example, system 1200 includes storage subsystem 1280 to store data in a nonvolatile manner. In one example, in certain system implementations, at least certain components of storage 1280 can overlap with components of memory subsystem 1220. Storage subsystem 1280 includes storage device(s) 1284, which can be or include any conventional medium for storing large amounts of data in a nonvolatile manner, such as one or more magnetic, solid state, or optical based disks, or a combination. Storage 1284 holds code or instructions and data 1286 in a persistent state (i.e., the value is retained despite interruption of power to system 1200). Storage 1284 can be generically considered to be a “memory,” although memory 1230 is typically the executing or operating memory to provide instructions to processor 1210. Whereas storage 1284 is nonvolatile, memory 1230 can include volatile memory (i.e., the value or state of the data is indeterminate if power is interrupted to system 1200). In one example, storage subsystem 1280 includes controller 1282 to interface with storage 1284. In one example controller 1282 is a physical part of interface 1214 or processor 1210 or can include circuits or logic in both processor 1210 and interface 1214.

A power source (not depicted) provides power to the components of system 1200. More specifically, power source typically interfaces to one or multiple power supplies in system 1200 to provide power to the components of system 1200. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1200 can be implemented using interconnected compute sleds of processors, memories, storages, network interfaces, and other components. High speed interconnects can be used such as PCIe, Ethernet, or optical interconnects (or a combination thereof).

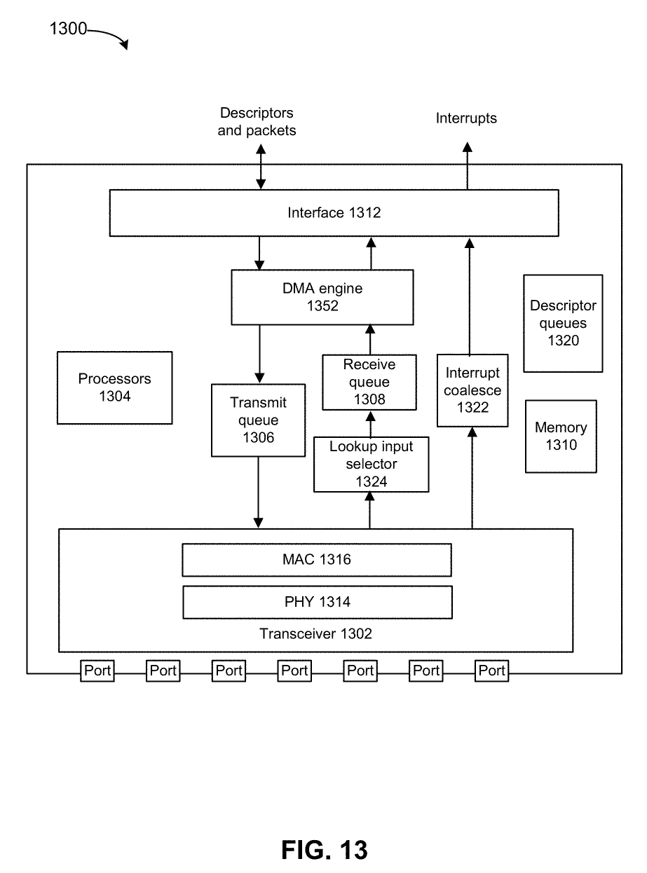

FIG. 13 depicts a network interface. Various embodiments can use the network interface or be used by the network interface. For example, a data center or server can use the network interface. For example, scheduling use of a transmit port can use various embodiments whereby multiple processors or schedulers request use of a port and a selection of a request is granted. Network interface 1300 can use transceiver 1302, processors 1304, transmit queue 1306, receive queue 1308, memory 1310, and bus interface 1312, and DMA engine 1352. Transceiver 1302 can be capable of receiving and transmitting packets in conformance with the applicable protocols such as Ethernet as described in IEEE 1302.3, although other protocols may be used. Transceiver 1302 can receive and transmit packets from and to a network via a network medium (not depicted). Transceiver 1302 can include PHY circuitry 1314 and media access control (MAC) circuitry 1316. PHY circuitry 1314 can include encoding and decoding circuitry (not shown) to encode and decode data packets according to applicable physical layer specifications or standards. MAC circuitry 1316 can be configured to assemble data to be transmitted into packets, that include destination and source addresses along with network control information and error detection hash values. Processors 1304 can be any a combination of a: processor, core, graphics processing unit (GPU), field programmable gate array (FPGA), application specific integrated circuit (ASIC), or other programmable hardware device that allow programming of network interface 1300. For example, processors 1304 can provide for identification of a resource to use to perform a workload and generation of a bitstream for execution on the selected resource. For example, a “smart network interface” can provide packet processing capabilities in the network interface using processors 1304.

Packet allocator 1324 can provide distribution of received packets for processing by multiple CPUs or cores using timeslot allocation described herein or RSS. When packet allocator 1324 uses RSS, packet allocator 1324 can calculate a hash or make another determination based on contents of a received packet to determine which CPU or core is to process a packet.

Interrupt coalesce 1322 can perform interrupt moderation whereby network interface interrupt coalesce 1322 waits for multiple packets to arrive, or for a time-out to expire, before generating an interrupt to host system to process received packet(s). Receive Segment Coalescing (RSC) can be performed by network interface 1300 whereby portions of incoming packets are combined into segments of a packet. Network interface 1300 provides this coalesced packet to an application.

Direct memory access (DMA) engine 1352 can copy a packet header, packet payload, and/or descriptor directly from host memory to the network interface or vice versa, instead of copying the packet to an intermediate buffer at the host and then using another copy operation from the intermediate buffer to the destination buffer.

Memory 1310 can be any type of volatile or non-volatile memory device and can store any queue or instructions used to program network interface 1300. Transmit queue 1306 can include data or references to data for transmission by network interface. Receive queue 1308 can include data or references to data that was received by network interface from a network. Descriptor queues 1320 can include descriptors that reference data or packets in transmit queue 1306 or receive queue 1308. Bus interface 1312 can provide an interface with host device (not depicted). For example, bus interface 1312 can be compatible with PCI, PCI Express, PCI-x, Serial ATA, and/or USB compatible interface (although other interconnection standards may be used).

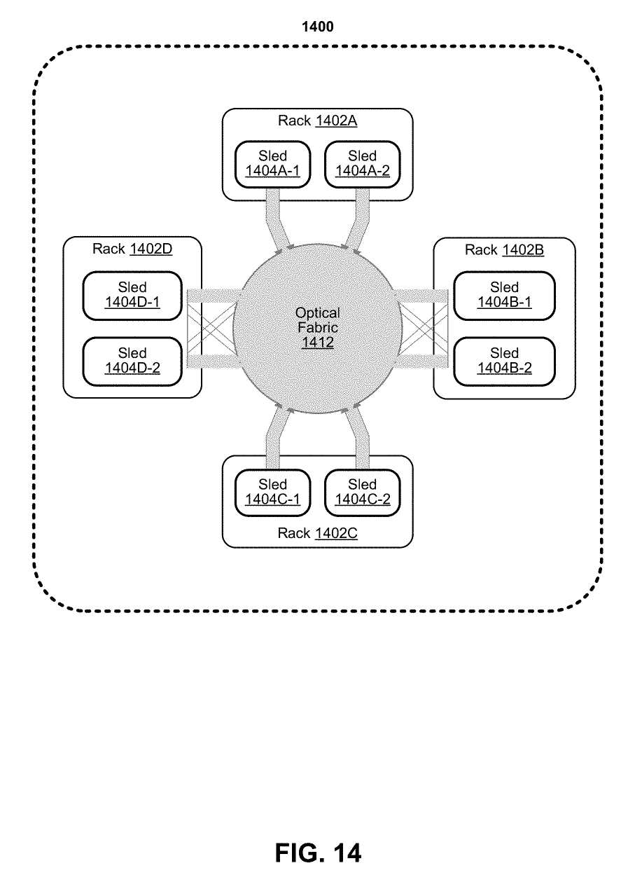

FIG. 14 depicts an example of a data center. Various embodiments can be used in or with the data center of FIG. 14. For example, a data center can use a network interface, smart network interface to perform arbitration of a use of a network interface port. As shown in FIG. 14, data center 1400 may include an optical fabric 1412. Optical fabric 1412 may generally include a combination of optical signaling media (such as optical cabling) and optical switching infrastructure via which any particular sled in data center 1400 can send signals to (and receive signals from) the other sleds in data center 1400. The signaling connectivity that optical fabric 1412 provides to any given sled may include connectivity both to other sleds in a same rack and sleds in other racks. Data center 1400 includes four racks 1402A to 1402D and racks 1402A to 1402D house respective pairs of sleds 1404A-1 and 1404A-2, 1404B-1 and 1404B-2, 1404C-1 and 1404C-2, and 1404D-1 and 1404D-2. Thus, in this example, data center 1400 includes a total of eight sleds. Optical fabric 14012 can provide sled signaling connectivity with one or more of the seven other sleds. For example, via optical fabric 14012, sled 1404A-1 in rack 1402A may possess signaling connectivity with sled 1404A-2 in rack 1402A, as well as the six other sleds 1404B-1, 1404B-2, 1404C-1, 1404C-2, 1404D-1, and 1404D-2 that are distributed among the other racks 1402B, 1402C, and 1402D of data center 1400. The embodiments are not limited to this example. For example, fabric 1412 can provide optical and/or electrical signaling.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.”

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

What is claimed is:

1. An apparatus comprising:
a multiplexer;
at least two fixed priority arbiters; and
a mask unit, wherein:
the multiplexer is to receive outputs from the at least two fixed priority arbiters and the multiplexer is to provide a granted request,
the at least two fixed priority arbiters are configurable as a round robin priority arbiter,
the mask unit is to determine a mask to mask at least zero low priority requesters to adjust a highest priority level of a first fixed priority arbiter, and
the multiplexer is to provide a granted request and the mask unit is to determine a mask to mask at least zero low priority requesters within a first clock cycle.

2. The apparatus of claim 1, wherein:
the mask unit comprises a first masking unit and a second masking unit;
the first masking unit is to provide an output that is to mask or unmask an input from a first requester based on the determined mask; and
the second masking unit is to provide an output that is to mask or unmask an input from a second requester based on the determined mask.

3. The apparatus of claim 2, wherein during a second clock cycle after the first clock cycle, the first fixed priority arbiter is to receive a first input from the first masking unit and a second input from the second masking unit.

4. The apparatus of claim 1, wherein to determine a mask to mask at least zero low priority requesters, the mask unit is to:
determine which request is granted;
traverse at least one branch that includes the granted request to identify a requester having an associated request granted and identify any lower priority requester and any higher priority requester; and
traverse at least zero branch that does not include the granted request to identify any lower priority requester or any higher priority requester.

5. The apparatus of claim 4, wherein to determine a mask to mask at least zero low priority requesters, the mask unit is to:
cause generation of at least one signal to identify any requester that is at or a lower priority than the requester having an associated request granted and
cause generation of at least one signal to identify any requester that is a higher priority than the requester having an associated request granted.

6. The apparatus of claim 5, wherein to determine a mask to mask at least zero low priority requesters, the mask unit is to:
apply the generated at least one signal to identify any requester that is at or a lower priority than the requester having an associated request granted to mask any request from a requester that is at or a lower priority than the requester having an associated request granted and
apply the generated at least one signal to identify any requester that is a higher priority than the requester having an associated request granted to not mask any request from a requester that is at higher priority than the requester having an associated request granted.

7. The apparatus of claim 1, comprising a network interface, host computer, data center, rack, or compute sled.

8. A method comprising:
identifying a granted request from a requester based on an arbitration among multiple requesters;
traversing at least one branch that includes the granted request to identify a requester having an associated request granted and identify any lower priority requester and any higher priority requester;
traversing at least zero branch that does not include the granted request to identify any lower priority requester and any higher priority requester; and
masking requests from requesters that are identified as a requester of the granted request and any lower priority requester and transferring requests from requesters that are higher priority, wherein identifying a granted request from a requester based on an arbitration among multiple requesters and identify any lower priority requester and any higher priority requester occurs in at least a portion of a clock cycle.

9. The method of claim 8, wherein transferring requests from requesters that are higher priority comprises transferring requests from requesters that are higher priority to an arbiter.

10. The method of claim 8, wherein traversing at least one branch that includes the granted request to identify a requester having an associated request granted and identify any lower priority requester and any higher priority requester comprises:
asserting a grant signal at a root node for a branch that includes request granted and
asserting a priority spawn signal for a branch that does not include the request granted and is a lower priority than the request granted.

11. The method of claim 10, wherein traversing at least one branch that includes the granted request to identify a requester having an associated request granted and identify any lower priority requester and any higher priority requester comprises:
identifying any requester associated with a priority level lower than that of the requester of the granted request based on an asserted priority spawn signal and an asserted uptrace de-multiplexer configuration signal;
identifying any requester associated with a priority level higher than that of the requester of the granted request based on an unasserted priority spawn signal; and
identifying any requester associated with a priority level higher than that of the requester of the granted request based on an asserted priority spawn signal.

12. The method of claim 8, wherein traversing at least one branch that includes the granted request to identify a requester having an associated request granted and identify any lower priority requester and any higher priority requester is based on an uptrace de-multiplexer configuration signal indicating left or right side priority.

13. A computer-readable medium comprising instructions stored thereon, that if executed by at least one processor, cause the at least one processor to:
determine a request winner of requests from multiple requestors and
adjust a highest priority requestor for a next round of requests, wherein the adjust a highest priority requestor for a next round of requests comprises:
identify a first branch that includes the request winner;
identify a second branch that does not include the request winner;
identify all leaf nodes that are higher or lower priority than the request winner; and
mask lower priority requests based on the identified lower priority nodes and the request winner, wherein determine a request winner and identify all leaf nodes that are higher or lower priority than the request winner occurs in at least a portion of a clock cycle.

14. The computer-readable medium of claim 13, wherein the at least one processor is to identify a requester having an associated request granted and identify any lower priority requester and any higher priority requester based on an uptrace de-multiplexer configuration signal indicating left or right side priority.

15. The computer-readable medium of claim 13, wherein the at least one processor is to identify a requester having an associated request granted and identify any lower priority requester and any higher priority requester based on a priority spawn direction signal from a parent node and a grant direction signal from a parent node.

16. A system comprising:
a network interface;
at least one processor to provide at least one request to use a resource;
at least two arbiters, wherein at least one fixed priority arbiter is to determine a request to grant; and
a mask unit to determine zero or more requests to mask to adjust a highest priority level of a fixed priority arbiter in a subsequent request round, wherein to determine a request to grant and determine zero or more requests to mask occur in a portion of a single clock cycle.

17. The system of claim 16, wherein to determine zero or more requests to mask, the mask unit is to:
determine which request is granted;
identify a requester having an associated request granted;
identify any lower priority requester; and
identify any higher priority requester.

18. The system of claim 16, wherein to identify any lower priority requester and any higher priority requester is based on an uptrace de-multiplexer configuration signal indicating left or right side priority and based on a priority spawn direction signal from a parent node and a grant direction signal from a parent node.

19. The system of claim 16, wherein the resource comprises a port on a network interface and the network interface is to provide at least one request to use a resource.

20. The system of claim 16, comprising a compute sled, rack, or server computer.
